(19) United States
(12) Patent Application Publication
(10) Pub. No.: US 2015/0032650 A1
(43) Pub. Date: Jan. 29, 2015

(54) METHOD OF VERIFYING REVIEW

(71) Applicant: Yakov Z. Mermelstein, Spring Valley, NY (US)

(72) Inventor: Yakov Z. Mermelstein, Spring Valley, NY (US)

(21) Appl. No.: 13/949,583

(22) Filed: Jul. 24, 2013

(51) Int. Cl. G06Q 30/02; G06Q 30/00; H04W 4/02

(52) U.S. Cl. CPC G06Q 30/0282; H04W 4/021; G06Q 30/0185
USPC 705/318

(57) ABSTRACT

The Invention involves using GPS technology to determine where a person has been and then permitting posting of reviews of subjects only if the reviewer has visited that subject within a specified period of time.

### FIELD OF THE INVENTION

This invention relates to the entertainment and travel industry and, more particularly, to a method of verifying reviews.

### BACKGROUND OF THE INVENTION

In today's fast moving times, people need information, and they need it fast. When people want to go, for example, to a movie or a restaurant, they first want to check what other people say about it.

By means of the Internet, people can quickly look up reviews of just about anything. The problem is that people can post comments and reviews of anything without any verification. In fact people not infrequently post reviews of movies they did not see and restaurants where they have not eaten. Accordingly, it is important to develop a system for verifying reviews, so that people can more comfortably rely on them.

Therefore, there is a need in the industry for a more reliable procedure for verifying reviews.

### SUMMARY OF THE INVENTION

These and other objects of the invention are achieved with a method for verifying reviews.

According to the Invention, in its simplest, basic form, it involves using GPS technology to determine where a person has been and then permitting posting of reviews of subjects only if the reviewer has visited that subject within a specified period of time.

In the preferred embodiment, a method of verifying reviews includes identifying a location of a person and maintaining a log of locations at which this person has been during a predetermined time frame; this person generating a review of a subject; verifying that within a predetermined time frame the person was at the subject; and storing the review in a universally accessible electronic location.

Another embodiment involves a method of verifying reviews comprising: maintaining an electronic log of interactions between a person and a subject; the person generating a review of the subject; confirming this person has interacted with the subject within a specified period of time; and storing the review in a universally accessible electronic location.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention.

The invention will now be described in connection with certain preferred embodiments with reference to the following illustrative figures so that it may be more fully understood.

FIGS. 1-2 are flow charts, showing the process of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

For purposes of the invention, the term portable electronic device includes any portable device that may be used for electronic communication, including, but not limited to, mobile devices, cell phones, smart phones, hand held computers, laptop computers, palm top computers, personal digital assistant (PDA), electronic pads and/or tablets.

The term Global Positioning System should also include any communication system that helps the device determine location, and it is not limited to and may include “WIFI,” “Bluetooth,” “NFC” and/or “GPS.” Herein after the term GPS is being used to include all these applicable protocols for global positioning.

According to the Invention, in its simplest, basic form, it involves using GPS technology to determine where a person has been and then permitting posting of reviews of subjects only if the reviewer has visited that subject within a specified period of time.

By the term subject is meant anything that can be the subject of a review. Most typically it may be a movie or restaurant, but it can, inter alia, be a historical site or museum, a place, a retail store, a government or business office, a business (like FedEx or Apple or Amazon.com), professional services (like doctors, lawyers, accountants) etc.

The GPS monitors where the person has been and generates a log. When a person creates a review of a subject, the log is automatically checked to see if the person has been at that subject with a specified time frame. For example, reviews may be permitted if the person has been at the subject within the last week, or fortnight or even the last month. On the other hand, if the reviewer has not been there for a year, the review may be blocked.

Once it confirmed that the reviewer has been at the subject, the review is posted on a universally electronic accessible medium, like the Internet.

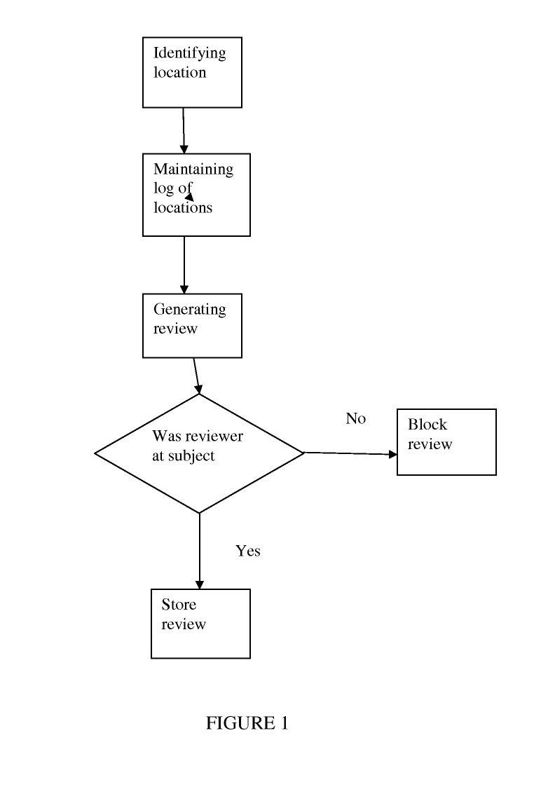

In the preferred embodiment of the invention (FIG. 1), a method of verifying reviews includes identifying a location of a person and maintaining a log of locations at which this person has been during a predetermined time frame; this person generating a review of a subject; verifying that within a predetermined time frame the person was at the subject; and storing the review in a universally accessible electronic location.

By means of GPS, the location of a person is easily determined by determining the location of his portable electronic device. Nowadays most portable electronic devices, especially smart phones and IPads, have build GPS capability. Then, the location information is stored in an electronic log.

Hence, according to the method, identifying the location of said first person includes using GPS to determine a physical location of a portable electronic device of the first person. Then this location information is saved in an electronic log for future reference.

After visiting a subject, a person may decide to write a review of it. As mentioned, the subject could be, for example, a movie, a restaurant, a historical place, a lawyer or a business. Once the review is completed, automatically the log of locations is checked to see if the reviewer was actually at the subject.

Preferably, checked the log of locations is time based. In other words, a prescribed time is entered into the log. This means that reviews are permitted if they are written within a prescribed time after visiting the subject and blocked if the reviewer has not visited the subject or has not been there within a predetermined time frame.

According to the method herein, the reviews are stored on the universally accessible electronic location if they are written within the prescribed time after visiting the subject. The reviews are blocked from being stored on the universally accessible electronic location if the person has not visited the subject or has not been there within said predetermined time frame

This time frame can be set for any appropriate time and can be different for different types of subjects. Restaurant reviews may be blocked if they are not done within a week or a month of the visit. On the other hand even a year old visit may be okay for a review on a historical site.

The predetermined time frame is based on the nature of the subject. Based on the nature of the subject the predetermined time frame is set. For subjects (like restaurants) which may change often, the time frame may be short, like a week or a month. Subjects that change infrequently, like a historical site, may have a longer time frame, like a year.

The universally accessible electronic location where the review can be stored may be any Internet site or even on a cloud or server.

According to another aspect of the invention, instead of using GPS, some other means is used to see if the reviewer has had sufficient interaction with the subject for him to be able to post a review.

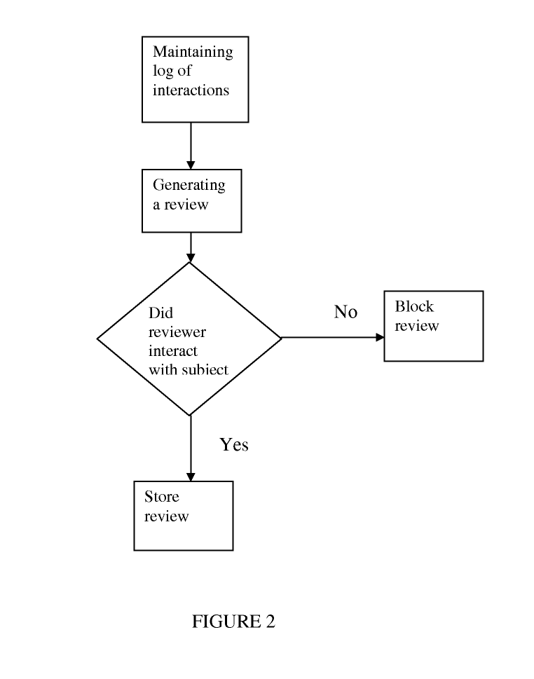

In an alternate embodiment of the invention (FIG. 2), a method of verifying reviews comprising: maintaining an electronic log of interactions between a person and a subject; the person generating a review of the subject; confirming this person has interacted with the subject within a specified period of time; and storing the review in a universally accessible electronic location.

According to this alternate embodiment, any reasonable activity may be used to confirm that a person has had sufficient contact with the subject to as to permit a review.

One preferred way to determine if a person has interacted with a subject is to search his electronic calendar. Generally a person lists his meetings and travel on his electronic calendar. Therefore, if the electronic calendar shows a trip or visit to the subject within the predetermined time, the review would be accepted; otherwise it would be blocked.

Therefore, according to this, maintaining an electronic log of interactions includes entries on an electronic calendar of said person and confirming the person has interacted includes a search of said electronic calendar for entries pertaining to the subject.

Another way is to maintain an electronic log of purchases, credit card activity, travel reservations and tickets, phone calls, e mail, twitters, communications, visits, and other interactions with the subject. Each entry would preferably include a date and a short summary of the interaction. In this way, the electronic log may be searched to determine if there were interactions during the predetermined time. If so the review would be accepted; and, if not, the review would be blocked.

Therefore, according to this, maintaining an electronic log of interactions includes an electronic log of purchases, credit card activity, travel reservations and tickets, phone calls, e mail, twitters, communications, physical visits, visits to a website of or about the subject, and other interactions with the subject and confirming said person has interacted includes a search of said electronic log for entries pertaining to said subject.

According to this method, reviews are stored on the universally accessible electronic location if they are written within the specified period time after interacting with said subject. Further, reviews are blocked from being stored on the universally accessible electronic location if the person has not interacted with the subject within the specified period of time.

Here too the universally accessible electronic location can be an Internet site or a cloud or a server.

As in the first embodiment, here too the specified period of time can be based on the nature of the subject.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method of verifying reviews comprising:
A. Identifying a location of a person and maintaining a log of locations at which said person has been during a predetermined time frame;
B. Said person generating a review of a subject;
C. Verifying that within said predetermined time frame said person was at said subject; and
D. Storing said Review in a universally accessible electronic location.

2. A method according to claim 1 wherein identifying a location includes using GPS to determine a physical location of a portable electronic device of said person.

3. A method according to claim 1 wherein said reviews are stored on said universally accessible electronic location if they are written within said prescribed time after visiting the subject.

4. A method according to claim 1 wherein said reviews are blocked from being stored on said universally accessible electronic location if the person has not visited the subject or has not been there within said predetermined time frame.

5. A method according to claim 1 wherein said predetermined time frame is based on a nature of said subject.

6. A method according to claim 1 wherein said universally accessible electronic location being an Internet site or a cloud or a server.

7. A method of verifying reviews comprising:
A. Maintaining an electronic log of interactions between a person and a subject;
B. Said person generating a review of said subject
C. Confirming said person has interacted with said subject within a specified period of time; and
D. Storing said review in a universally accessible electronic location.

8. A method according to claim 7, wherein said maintaining an electronic log of interactions includes entries on an electronic calendar of said person and confirming said person has interacted includes a search of said electronic calendar for entries pertaining to said subject.

9. A method according to claim 7, wherein said maintaining an electronic log of interactions includes an electronic log of purchases, credit card activity, travel reservations and tickets, phone calls, e mail, twitters, communications, physical visits, visits to a website of or about the subject, and other interactions with the subject and confirming said person has interacted includes a search of said electronic log for entries pertaining to said subject.

10. A method according to claim 7 wherein said reviews are stored on said universally accessible electronic location if they are written within said specified period time after interacting with said subject.

11. A method according to claim 7 wherein said reviews are blocked from being stored on said universally accessible electronic location if the person has not interacted with the subject within said specified period of time.

12. A method according to claim 7 wherein said universally accessible electronic location being an Internet site or a cloud or a server.

13. A method according to claim 7 wherein the specified period of time being based on a nature of said subject.
